(19) United States
(12) Patent Application Publication
(10) Pub. No.: US 2016/0039261 A1
(43) Pub. Date: Feb. 11, 2016

(54) AIR-CONDITIONING DEVICE FOR VEHICLE

(71) Applicant: CALSONIC KANSEI CORPORATION, Saitama (JP)

(72) Inventors: Masaru AKAHANE, Saitama (JP); Keisuke KAWANISHI, Saitama (JP)

(21) Appl. No.: 14/780,182

(22) PCT Filed: Mar. 12, 2014
(86) PCT No.: PCT/JP2014/056479

§ 371 Date: Sep. 25, 2015

(30) Foreign Application Priority Data
Mar. 29, 2013 (JP) 2013-073725

(51) Int. Cl. B60H 1/00

(52) U.S. Cl. CPC B60H 1/00057; B60H 1/00271; B60H 1/00564

(57) ABSTRACT

A vehicle air-conditioning device having no unneeded structure and high scalability is provided. The vehicle air-conditioning device includes a device body which has two-divided first outer case and second outer case. The device body includes a second spacing element for forming a second space. The second space spacing element is placed in the first outer case and the second outer case to place the second space in a first space and face a second aperture formed in the device body. Further, the second spacing element is supported in the first outer case and the second outer case by an air passage forming wall which forms an air passage.

### CROSS-REFERENCE TO RELATED APPLICATION

The present application is based on and claims priority from Japanese Patent Application No. 2013-073725, filed Mar. 29, 2013, the disclosure of which is hereby incorporated by reference in its entirety.

### BACKGROUND

The present invention relates to an air-conditioning device for a vehicle which achieves high scalability while eliminating unneeded structure.

A vehicle such as an automobile includes an air-conditioning device for adjusting the temperature of a vehicle interior (see Japanese Laid-Open Patent Application Publication No. 2001-30733, for instance). There is a known vehicle air-conditioning device which includes two sections in a body to be able to independently control the temperatures of a front seat and a rear seat.

### SUMMARY

However, such an air-conditioning device specified for the independent temperature control over the front and rear seats needs to have a complex and special inner structure.

Further, the above-mentioned independent temperature control function of the air-conditioning device can be partially restricted or downgraded to change the specification of the air-conditioning device to a front-seat temperature control, for instance. However, this causes problems including the occurrence of an unnecessary or unused structure or space and an increase in weight corresponding to the unnecessary or unused structure, resulting in cost increases.

### Solution to Problem

In view of solving the above problems, the present invention includes a device body including a cooling-purpose thermal exchanger which cools air-conditioning air, a heating-purpose thermal exchanger which heats the air-conditioning air, an air passage including an air heating passage in which the heating-purpose thermal exchanger is provided and a cooled-air bypass to bypass the heating-purpose thermal exchanger, a mixing area in which heated air-conditioning air from the air heating passage and cooled air-conditioning air from the cooled-air bypass are mixed, a first space, and a first aperture and a second aperture on an outer surface to face the first space, wherein the device body includes two-divided, first outer case and second outer case, a second spacing element which forms a second space and is placed such that the second space is placed in the first space to face the second aperture, and an air passage forming wall which forms the air passage inside the first outer case and the second outer case and supports the second spacing element.

### BRIEF DESCRIPTION OF DRAWINGS

FIG. 1 is a perspective view of an entire air-conditioning device for a vehicle according to one embodiment.

FIG. 2 is an exploded perspective view of the air-conditioning device in FIG. 1.

FIG. 3 is a side view of the air-conditioning device in FIG. 1.

FIG. 4 is a front view of the air-conditioning device in FIG. 1.

FIG. 5 is a back view of the air-conditioning device in FIG. 1.

FIG. 6 is a plan view of the air-conditioning device in FIG. 1.

FIG. 7 is a vertical cross section view of the inner structure of a first space in FIG. 3.

FIG. 8 is a vertical cross section view of the inner structure of a second space in FIG. 3.

FIG. 9A is a perspective view of a second spacing element in FIG. 8 as seen from an upstream of an air-conditioning air flow.

FIG. 9B is a perspective view of the second spacing element in FIG. 8 as seen from a downstream of the air-conditioning air flow.

FIG. 10A is a side view of the second spacing element in FIG. 9.

FIG. 10B is a front view of the second spacing element in FIG. 9.

FIG. 10C is a back view of the second spacing element in FIG. 9.

FIG. 10D is a top view of the second spacing element in FIG. 9.

FIG. 11 is a horizontal cross section view of the air-conditioning device in FIG. 3 (along the A to A line).

FIG. 12 is a partially enlarged view of the air-conditioning device in FIG. 11.

FIG. 13 is a vertical cross section view of the top part of the air-conditioning device in FIG. 3 (along the B to B line).

FIG. 14A is a perspective view of (first inner case of) the second spacing element attached in a first outer case as seen laterally (from inside).

FIG. 14B is a perspective view of (first inner case of) the second spacing element attached in the first outer case as seen from a back side (from inside).

FIG. 15 is a perspective view of the second spacing element attached in the first outer case of FIG. 14 (as seen from outside).

FIG. 16 is a partially enlarged perspective view of a second aperture.

FIG. 17 is a perspective view of an entire vehicle air-conditioning device according to a variation of the embodiment.

FIG. 18 is an exploded perspective view of the air-conditioning device in FIG. 17.

FIG. 19 is a vertical cross section view of the inner structure of a first space in FIG. 17.

FIG. 20A is a side view of an inner partitioning element in FIG. 19.

FIG. 20B is a front view of the inner partitioning element in FIG. 19.

FIG. 20C is a back view of the inner partitioning element in FIG. 19.

FIG. 20D is a perspective view of the inner partitioning element in FIG. 19.

FIG. 21 is a horizontal cross section view of the air-conditioning device in FIG. 17 similar to FIG. 11.

FIG. 22 is a partially enlarged view of FIG. 21.

FIG. 23 is a vertical cross section view of the air-conditioning device in FIG. 17 similar to FIG. 13.

FIG. 24 is a partially enlarged view of FIG. 23.

### DESCRIPTION OF EMBODIMENTS

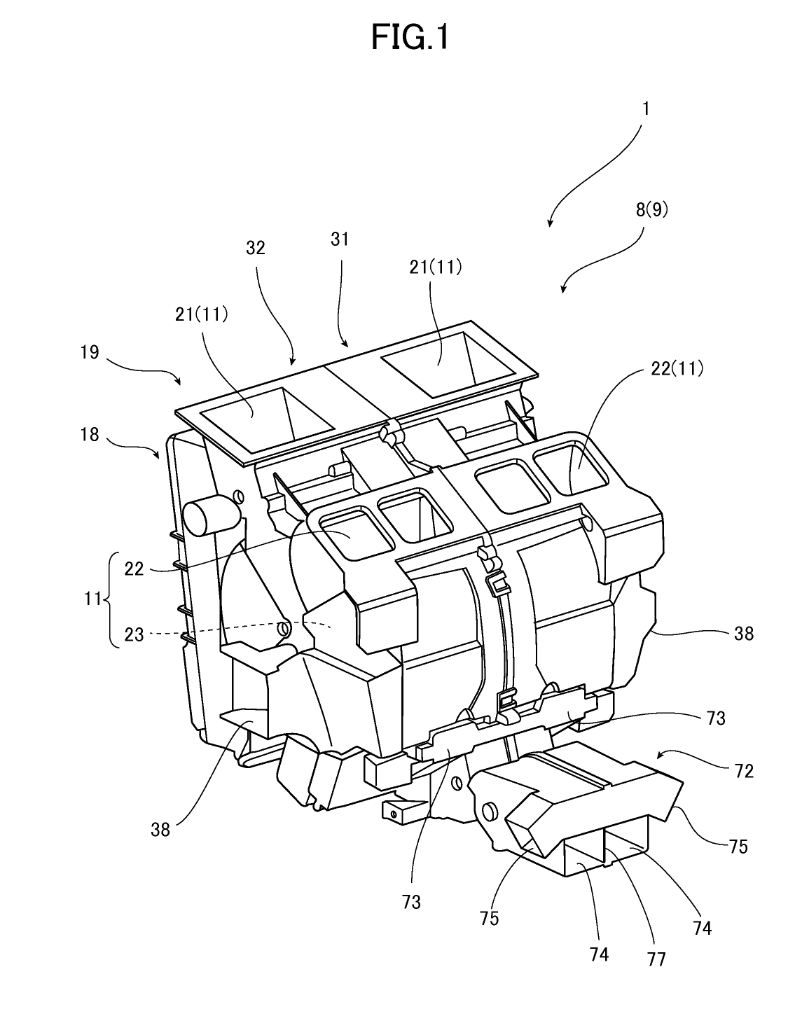

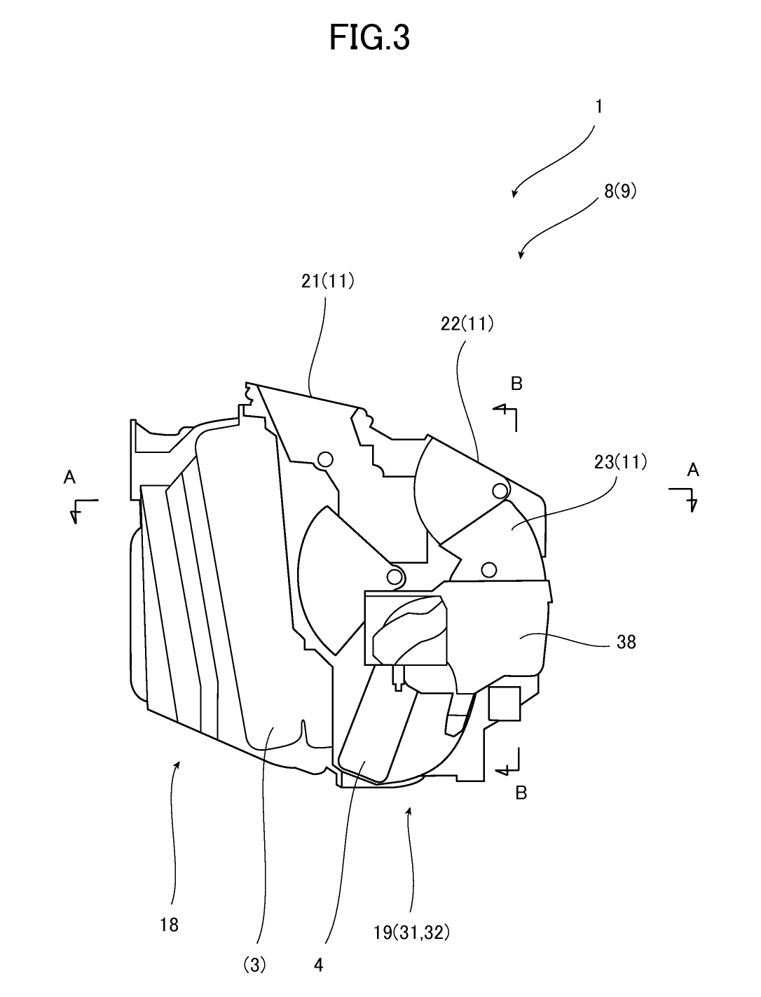

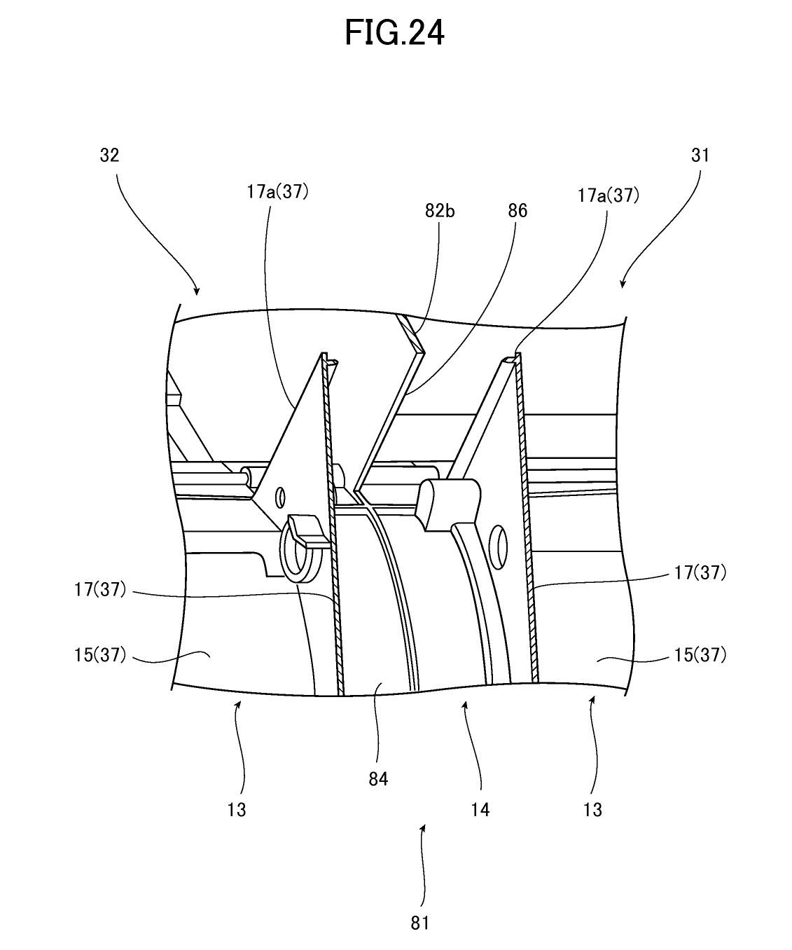

Hereinafter, one embodiment and examples will be described with reference to the accompanying drawings. FIG. 1 through FIG. 24 show the present embodiment and a variation of the present embodiment.

### First Embodiment

### <Structure>

Hereinafter, the structure of an air-conditioning device will be described.

Referring to FIG. 1 through FIG. 6, mainly, the perspective view in FIG. 1, a vehicle air-conditioning device 1 which controls the temperature of a vehicle interior is provided in a vehicle such as an automobile. FIG. 1 through FIG. 6 will be described later.

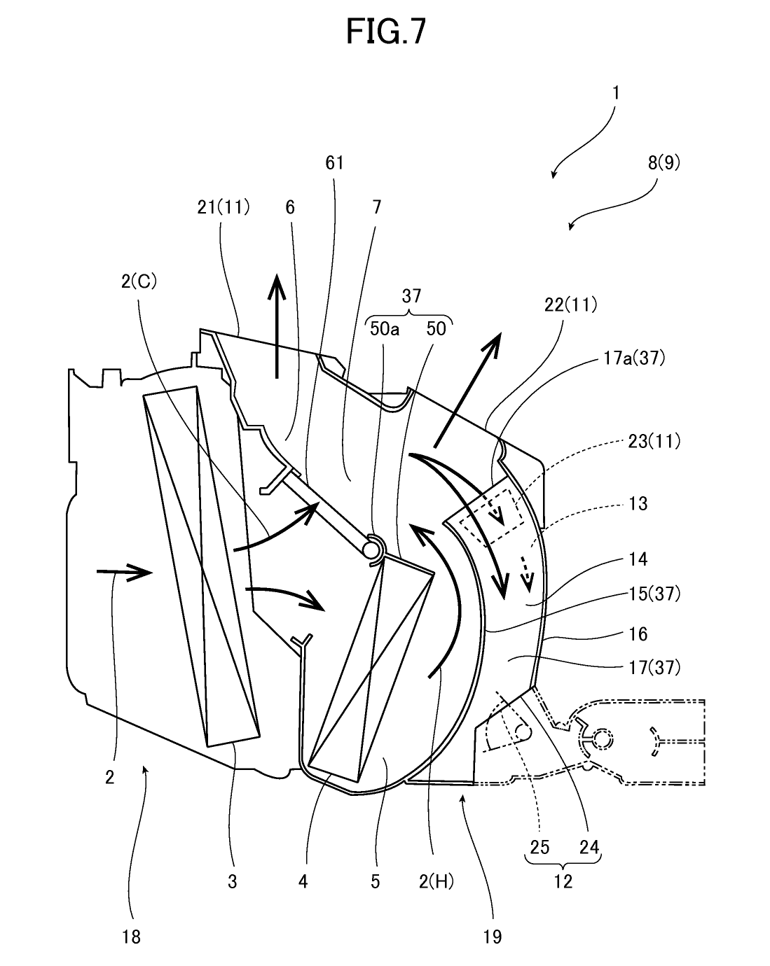

As shown in the vertical cross section view of FIG. 7, the air-conditioning device 1 includes a device body 8 having a cooling-purpose thermal exchanger 3 to cool air-conditioning air 2, a heating-purpose thermal exchanger 4 to heat the air-conditioning air 2, an air passage including an air heating passage 5 in which the heating-purpose thermal exchanger 4 is provided, and a cooled-air bypass 6 to bypass the heating-purpose thermal exchanger 4, and a mixing area 7 in which heated air-conditioning air 2(H) from the air heating passage 5 and cooled air-conditioning air 2(C) from the cooled-air bypass 6 are mixed.

The device body 8 includes a first space 9 inside and a first aperture 11 and a second aperture 12 on an outer face to face the first space 9.

### (Supplemental Explanation)

The above description is supplemented. The air-conditioning air 2 refers to temperature-controlled air or air to be controlled in temperature by the air-conditioning device 1.

The cooling-purpose thermal exchanger 3 is configured to cool the air-conditioning air 2 as an evaporator, for example, to cool the air-conditioning air 2 by use of evaporative latent heat of refrigerant. The cooling-purpose thermal exchanger 3 is positioned on an upstream side of the device body 8.

The heating-purpose thermal exchanger 4 is configured to heat the air-conditioning air 2 cooled by the cooling-purpose thermal exchanger 3 as a heater core, for example, to heat the air-conditioning air 2 by use of heat from engine cooling water. The heating-purpose thermal exchanger 4 is provided more downstream than the cooling-purpose thermal exchanger 3 in the direction of flow of the air-conditioning air 2.

The air heating passage 5 is a passage through which the air-conditioning air 2 is heated. The heating-purpose thermal exchanger 4 is placed in the middle of the air heating passage 5. The air-conditioning air 2 basically flows downward in the drawing in upstream of the heating-purpose thermal exchanger 4 and flows upward in downstream of the heating-purpose thermal exchanger 4 in the air heating passage 5.

The cooled-air bypass 6 is a bypass to allow the air-conditioning air 2 cooled by the cooling-purpose thermal exchanger 3 to bypass the heating-purpose thermal exchanger 4. The cooled-air bypass 6 is formed to directly connect an outlet of the cooling-purpose thermal exchanger 3 and an inlet of the mixing area 7. In the drawing the cooled-air bypass 6 is placed above the inlet of the air heating passage 5 between the cooling-purpose thermal exchanger 3 and the heating-purpose thermal exchanger 4.

The air passage is formed in the device body 8 for the air-conditioning air 2. The air passage includes a foot passage 13 and a rear passage 14 in addition to the air heating passage 5 and the cooled-air bypass 6.

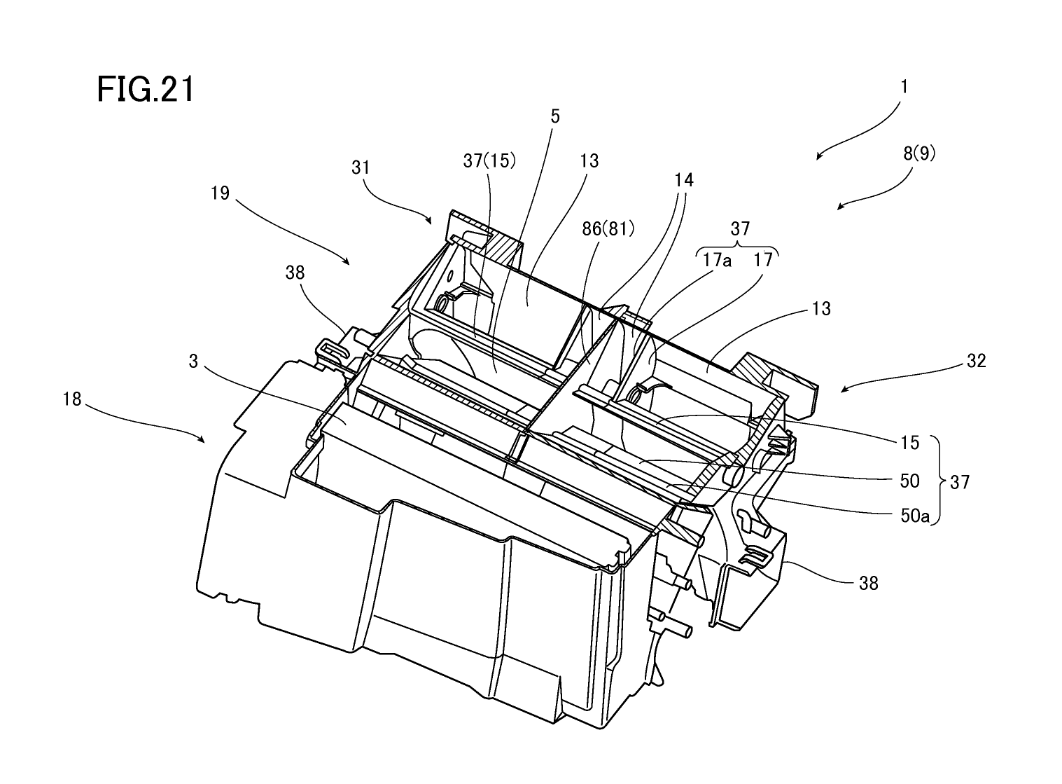

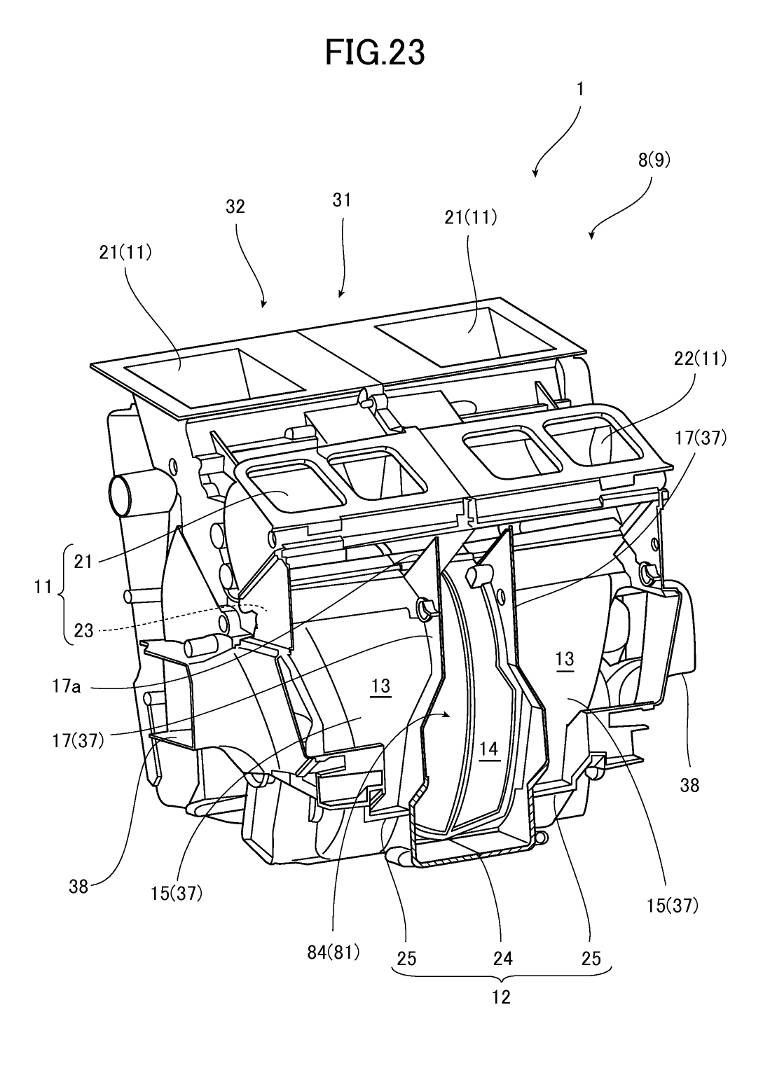

The foot passage 13 and the rear passage 14 are disposed between a rear wall 15 of the air heating passage 5 and a rear wall 16 of the device body 8 to be adjacent to each other in a vertical direction in FIG. 7 (FIGS. 21 to 24, especially, FIG. 23).

Partitions 17 parallel to FIG. 7 separate the foot passage 13 and the rear passage 14. The foot passage 13 is a back portion hidden by the partitions 17 and the rear passage 14 is in front of the partitions 17. The rear passage 14 is placed in one location at the center of the width in a front-back direction. The foot passage 13 is provided in pair at both ends of the rear passage 14. The air-conditioning air 2 flows downward in the foot passage 13 and the rear passage 14 in the drawing. The air-conditioning air 2 from the mixing area 7 is distributed at the top edges 17a of the partitions 17 into the rear passage 14 and the foot passage 13.

The mixing area 7 is intended for mixing the heated air-conditioning air 2(H) from the air heating passage 5 and the cooled air-conditioning air 2(C) from the cooled-air bypass 6 to homogenize temperatures. It is a mixing chamber or space placed to face the outlets of the air heating passage 5 and the cooled-air bypass 6. The mixing area 7 is positioned above each of the outlets.

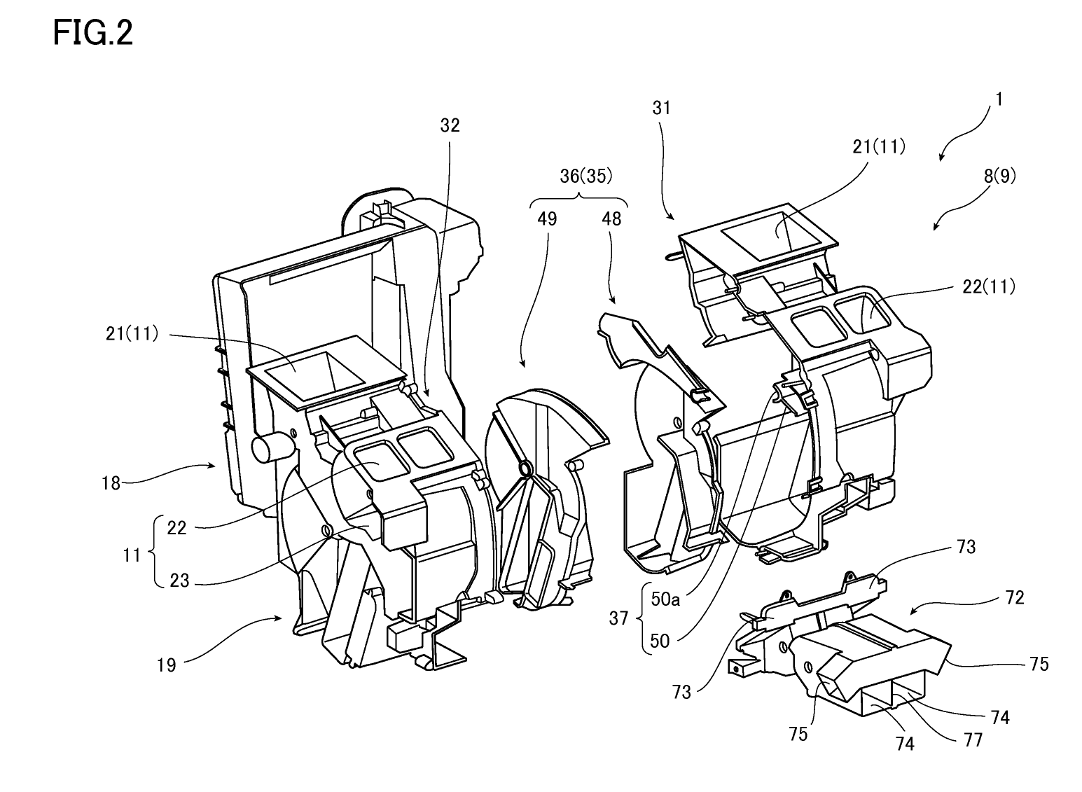

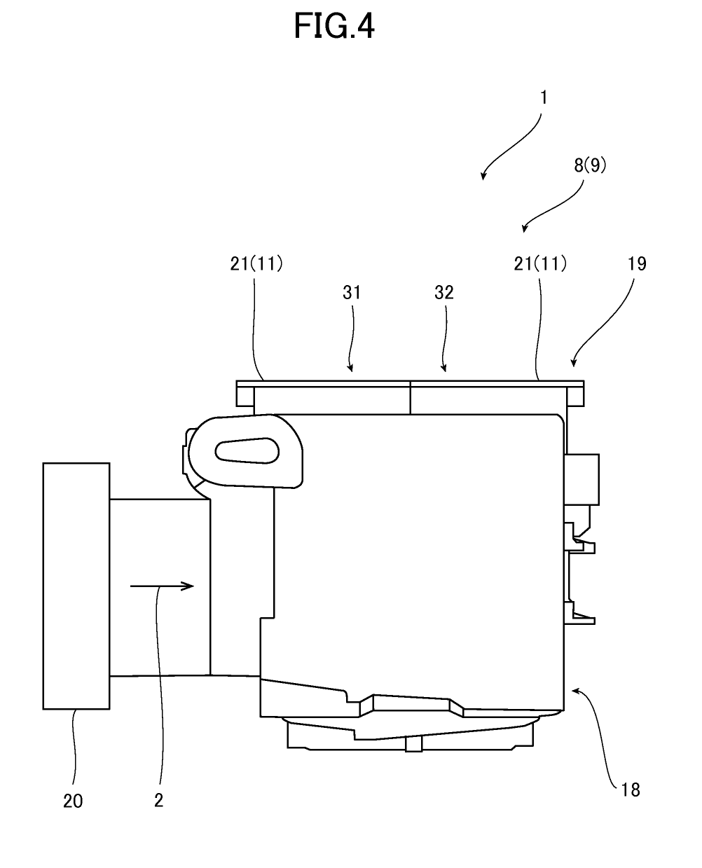

The device body 8 is a hollow case made from resin. Referring to FIG. 1 to FIG. 6, especially, the exploded perspective view of the FIG. 2, the device body 8 is a split structure of at least a front housing 18 which accommodates the cooling-purpose thermal exchanger 3 and a rear housing 19 which accommodates the heating-purpose thermal exchanger 4. However, the front housing 18 and the rear housing 19 can be integrally formed. A blower unit 20 in FIG. 4 is connected to the upstream of the front housing 18. The blower unit 20 is provided with a not-shown blower and intake unit. The rear housing 19 will be described in detail later.

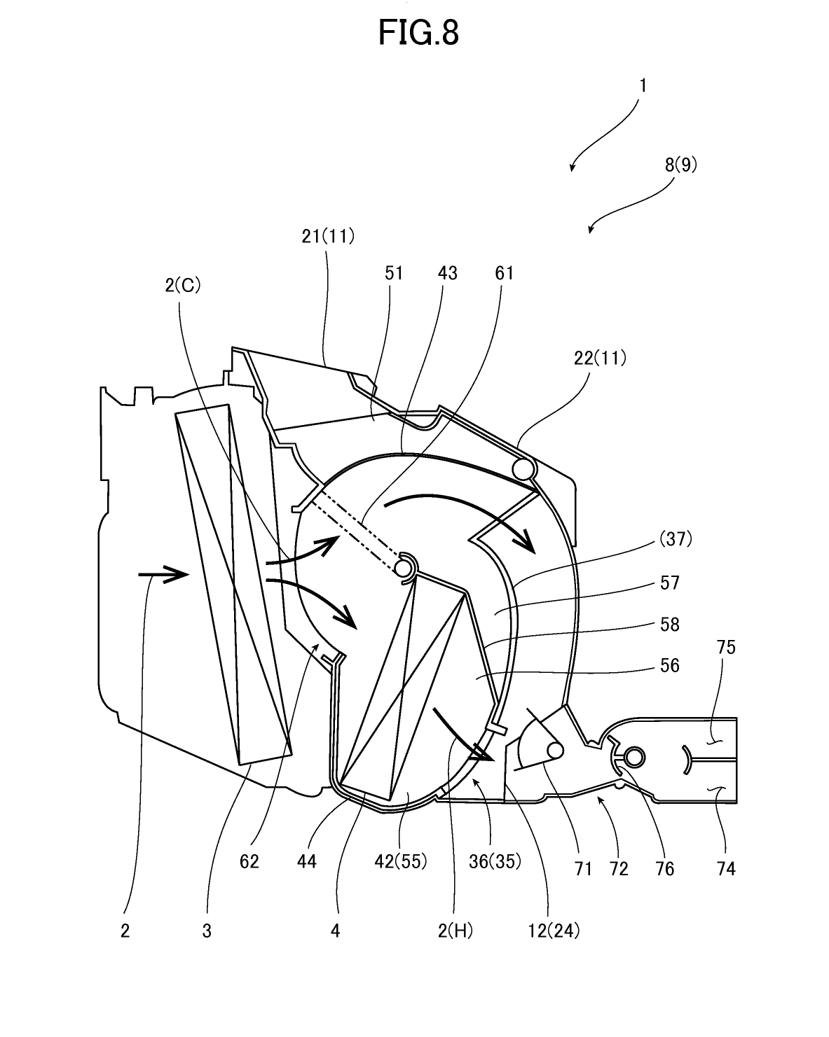

The first space 9 is an air conditioning space inside the device body 8. The first space 9 is an inner space of a later-described second spacing element 36 (FIG. 8 through FIGS. 10A to 10D) excluding a second space 35. The first space 9 includes the air heating passage 5, cooled-air bypass 6, mixing area 7, foot passage 13, and rear passage 14, as shown in FIG. 7.

The first aperture 11 is an outlet of the air-conditioning air 2 to a front seat. The first aperture 11 includes a defroster vent 21 from which the air-conditioning air 2 is blown to a windshield for anti-fog purposes, a vent 22 from which the air-conditioning air 2 is blown to the upper body or chest of a front-seat occupant, and a foot vent 23 from which the air-conditioning air 2 is blown to the lower body or feet of the front-seat occupant.

The defroster vent 21 is provided on the top of the device body 8 closer to the front side. The vent 22 is provided on the top of the device body 8 closer to the rear side and separated from the defroster 21. The foot vent 23 is formed in the vicinity of the inlet or the middle of the foot passage 13 to open the side face of the device body 8. The device body 8 is properly provided with not-shown mode doors to open and close the first aperture 11. The mode doors include a defroster door, a vent door, and a foot door, for example.

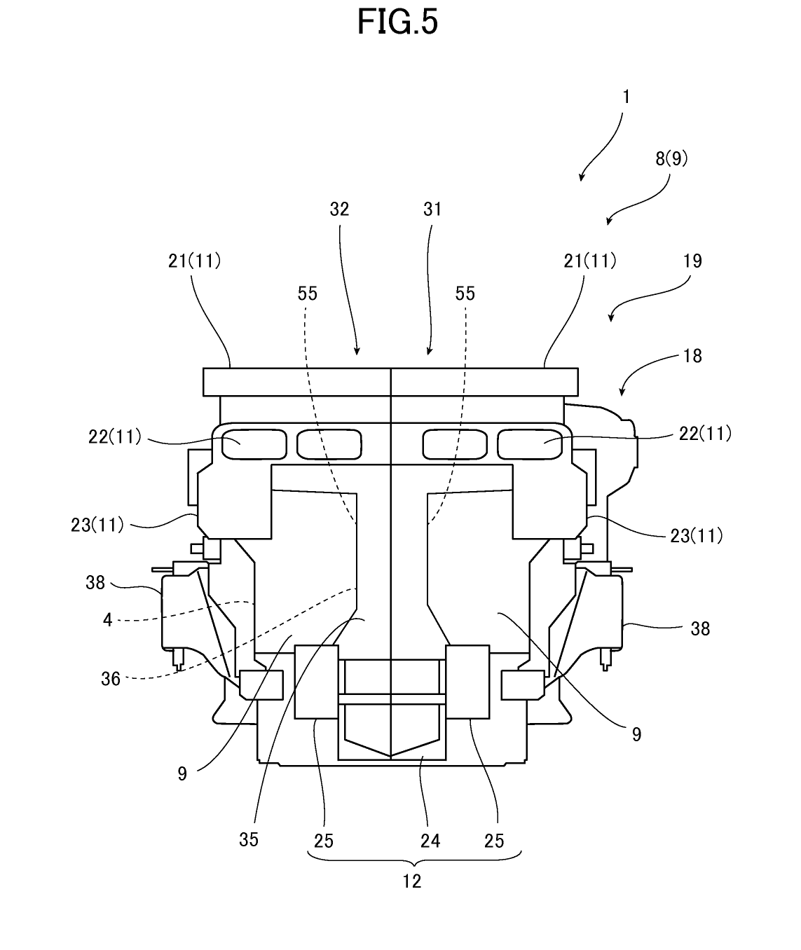

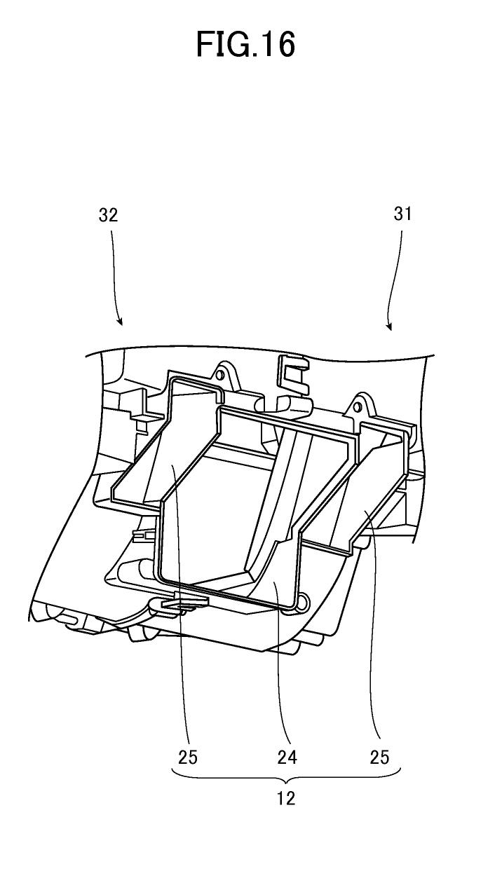

The second aperture 12 is an outlet of the air-conditioning air 2 for the rear seat, provided under the rear wall 16 of the device body 8. The second aperture 12 includes a second vent 24 for blowing the air-conditioning air 2 to the upper body or chest of a rear-seat occupant and a second foot vent 25 for blowing the air-conditioning air 2 to the lower body or feet of the rear-seat occupant (see FIGS. 5 and 16).

The second vent 24 is formed at the end, specifically, bottom end of the rear passage 14. The second foot vent 25 is formed at the end, specifically, bottom end of the foot passage 13. The second vent 24 is placed at a center of the width of the rear passage 14 while the second foot vent 25 is provided in pair at both sides of the width of the second vent 24.

In addition to the basic structure above, the air-conditioning device includes the following elements.

### (Structure 1)

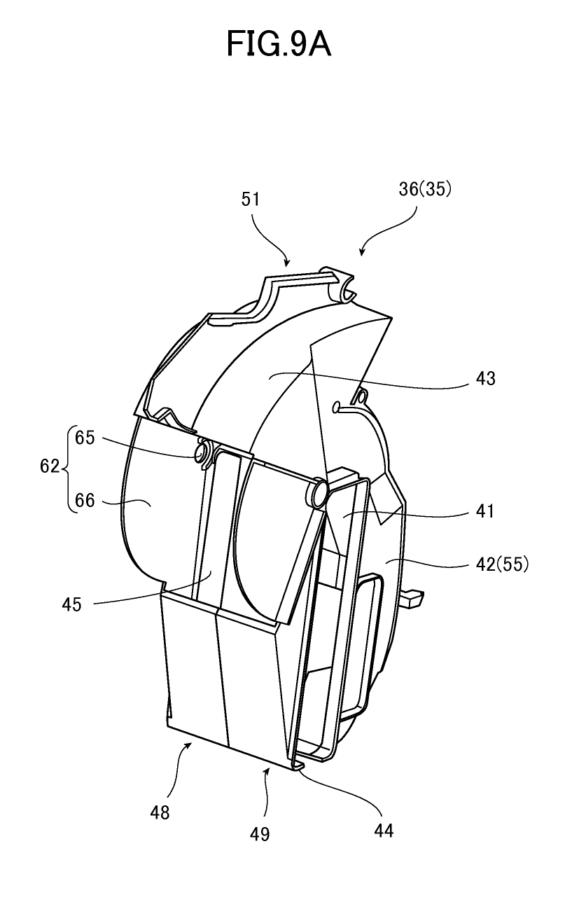

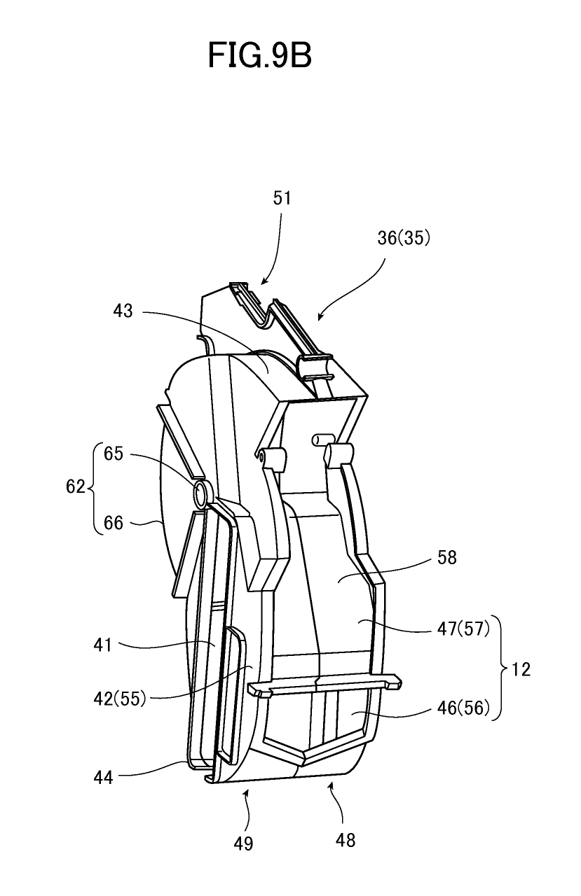

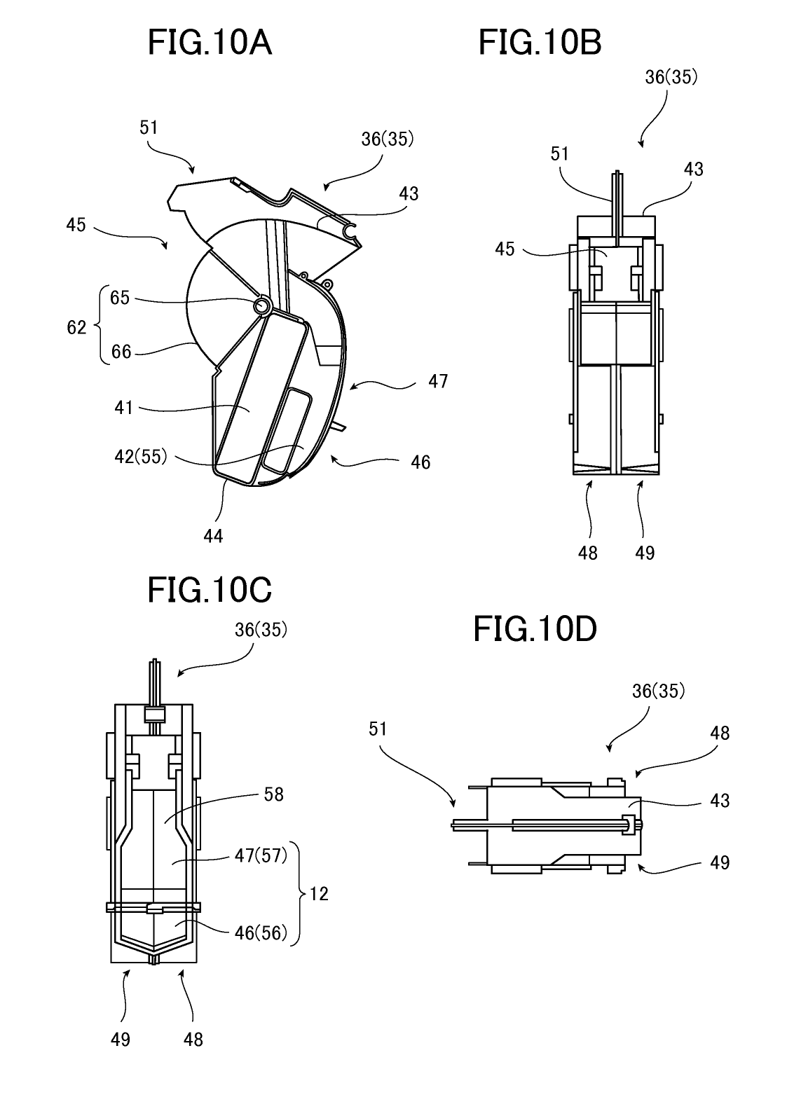

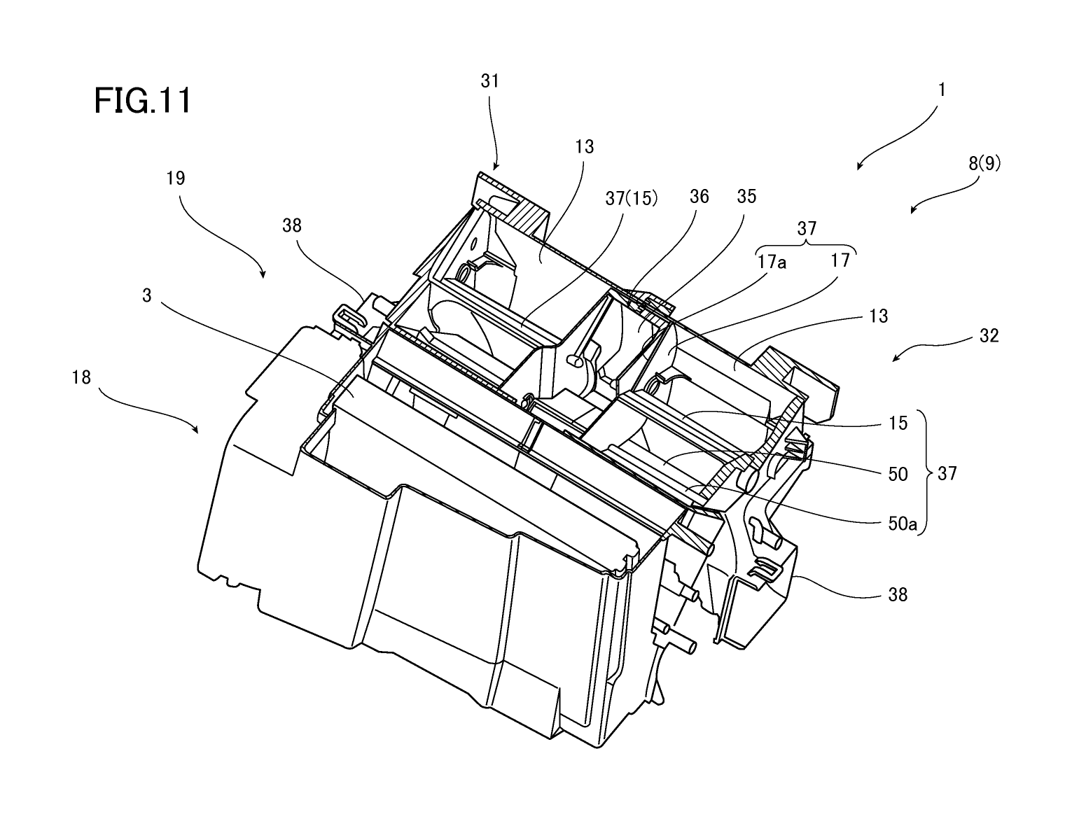

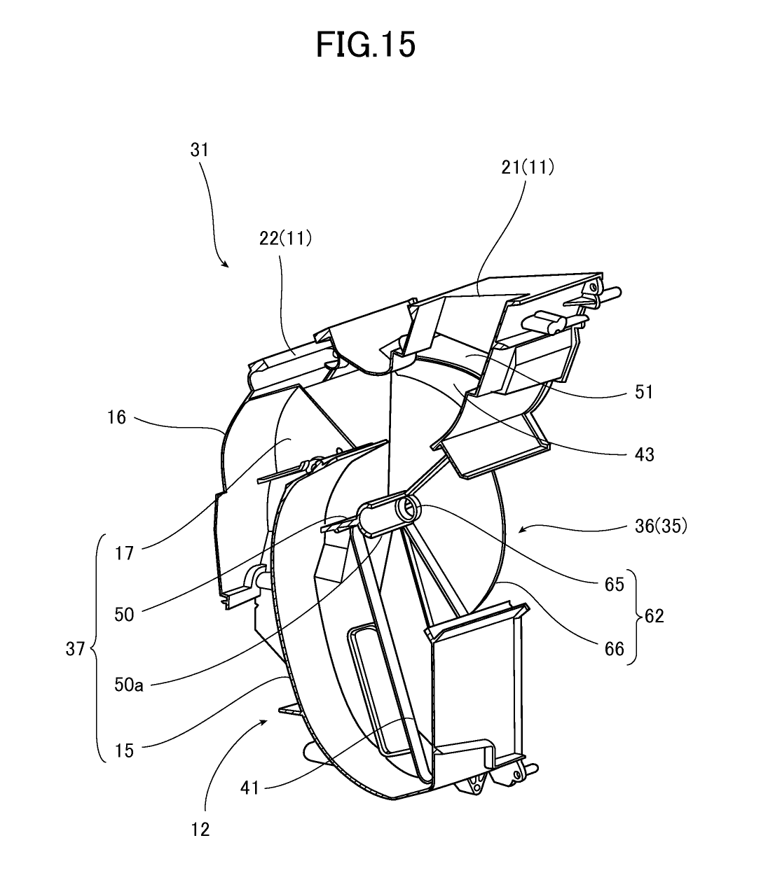

As shown in the perspective view and exploded perspective view of FIGS. 1 and 2, the device body 8 is divided into at least the first outer case 31 and the second outer case 32. In FIG. 8 the second spacing element 36 (FIGS. 9A, 9B, and 10A to 10D) is provided in the device body 8 to form the second space 35. The second spacing element 36 is disposed, facing the second aperture 12 such that the second space is formed in the first space 9. Further, the second spacing element 36 is supported by an air-passage forming wall 37 inside the first and second outer cases 31 and 32, referring to FIG. 11 (through FIG. 15).

### (Supplemental Explanation 1)

Herein, the first outer case 31 and the second outer case 32 literally form the outer face of the air-conditioning device 1 and are divided units of the device body 8 along the width. In this example the above rear housing 19 is divided at the center of the width into the first and second outer cases 31 and 32 of an approximately same size. For simple explanation, the first outer case 31 can be a right-side unit and the second outer case 32 can be a left-side unit or vice versa. Although a joining portion of the first and second outer cases 31 and 32 is not explicitly shown in the drawings, a fitting member by a concavo-convex fitting or an inlay fitting can be provided, for example. When the front housing 18 and the rear housing 19 are integrated as described above, the entire device body 8 is divided into the first outer case 31 and the second outer case 32.

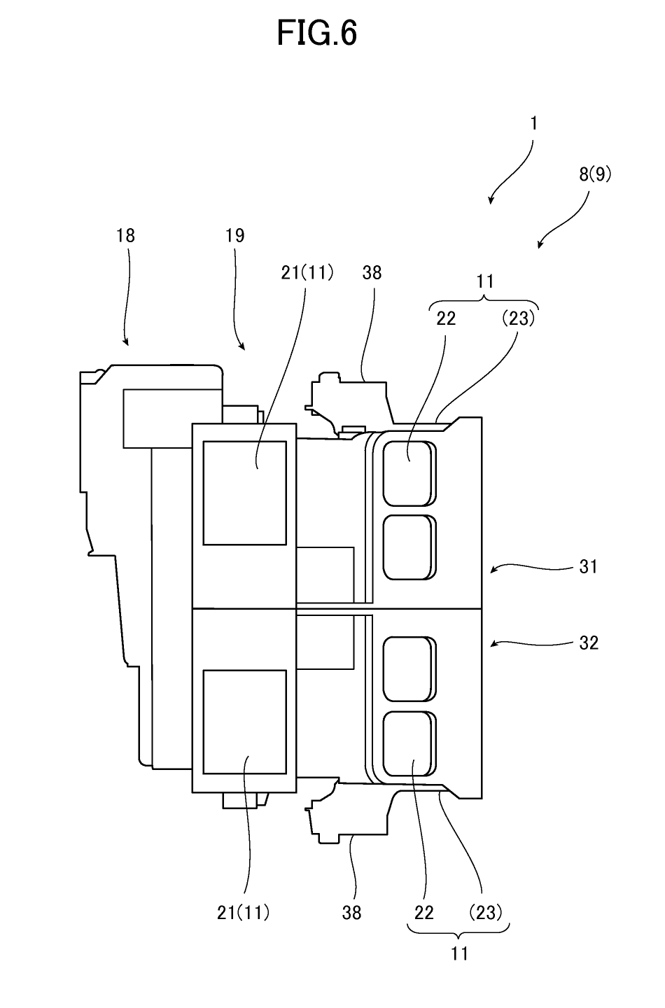

In addition, a foot duct 38 is a separate part which is attached on the side faces of the first outer case 31 and the second outer case 32 at the positions corresponding to the foot vent 23 when needed, to cover the foot vent 23 and guide the air-conditioning air 2 downward or sideways from the foot vent 23 (see FIGS. 1 and 6, for example).

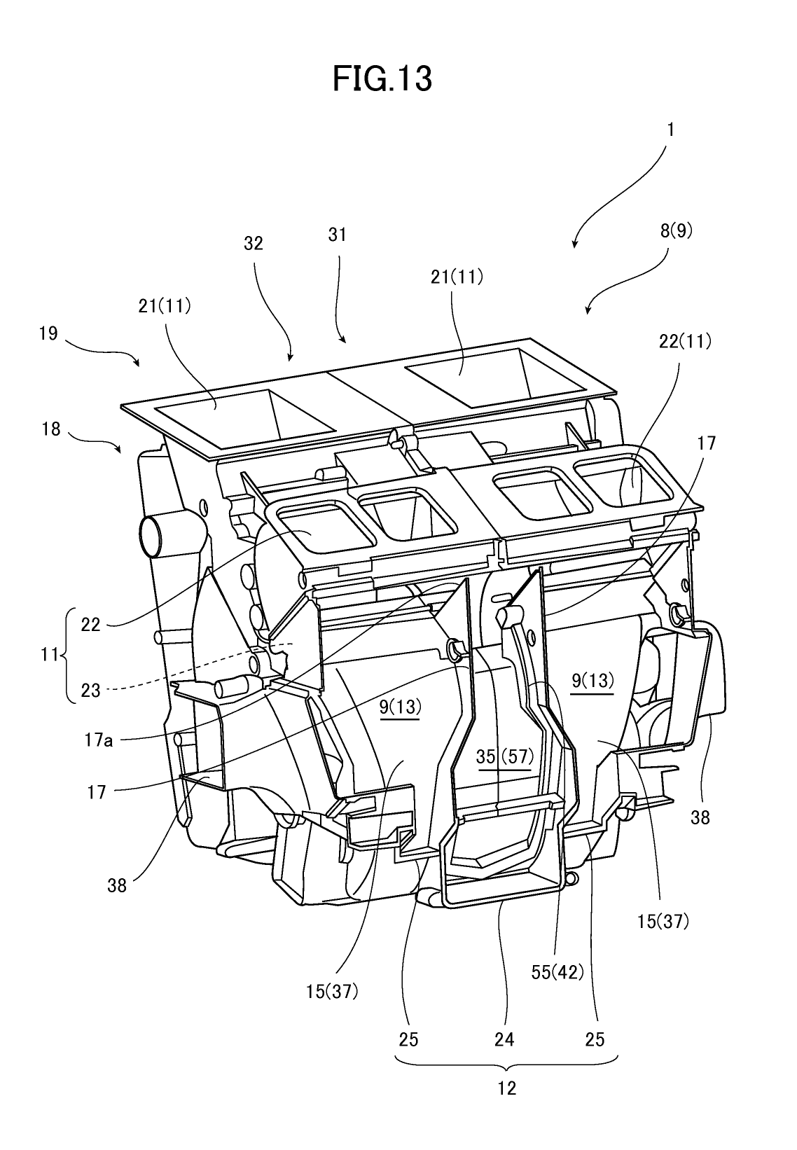

The second space 35 is an air-conditioning space for blowing the air-conditioning air 2 to the rear seat. Referring to FIG. 11 (through FIG. 13), the second space 35 has approximately the same width as that of the rear passage 14 and is placed at the center of the width of the device body 8 to be connected to the second aperture 35 via the rear passage 14. The first space 9 is divided into two by the second space 9, for example, horizontally. The second space 35 is formed to have approximately the same shape and size as those of the cross section of the essential part of the rear housing 19 of the device body 8, as laterally seen in FIG. 8.

The second spacing element 36 is intended for securing a passage of the air-conditioning air 2 to the second aperture 12 inside the device body 8. The second spacing element 36 can be referred to as an inner duct. The second spacing element 36 is detachably attached to the device body 8.

FIGS. 9A, 9B, and FIG. 10A to 10D show the second spacing element 36. The second spacing element 36 includes at least right and left side portions 42 with a hole 41 into which the heating-purpose thermal exchanger 4 is inserted laterally, for example, a later-described first area dividing wall 55, the top portion 43 connecting the tops of the right and left side portions 42, a bottom portion 44 connecting the bottoms of the right and left side portions 42, an aperture 45 working as an inlet of the air-conditioning air 2, and apertures 4, 47 working as an outlet of the air 2, The apertures 46, 47 are provided with a vertical interval and connected to the second aperture 12 and the rear passage 14.

The second spacing element 36 can be a single part or a combination of multiple parts. A combined second spacing element 36 can be vertically or horizontally divided. In the present embodiment it is horizontally divided into the first inner case 48 and the second inner case 49. For descriptive purposes the first inner case 48 can be a right-side section and the second inner case 49 can be a left-side section or vice versa. Although a joining portion of the first and second inner cases 48 and 49 is not explicitly shown in the drawings, a fitting member by a concavo-convex fitting or an inlay fitting can be provided, for example.

Since the second spacing element 36 is provided at the center of the width of the device body 8, the defroster 21 and the vent 22 are opened not to the center of the width but to both ends of the width, avoiding the position of the second spacing element 36, as shown in FIG. 1.

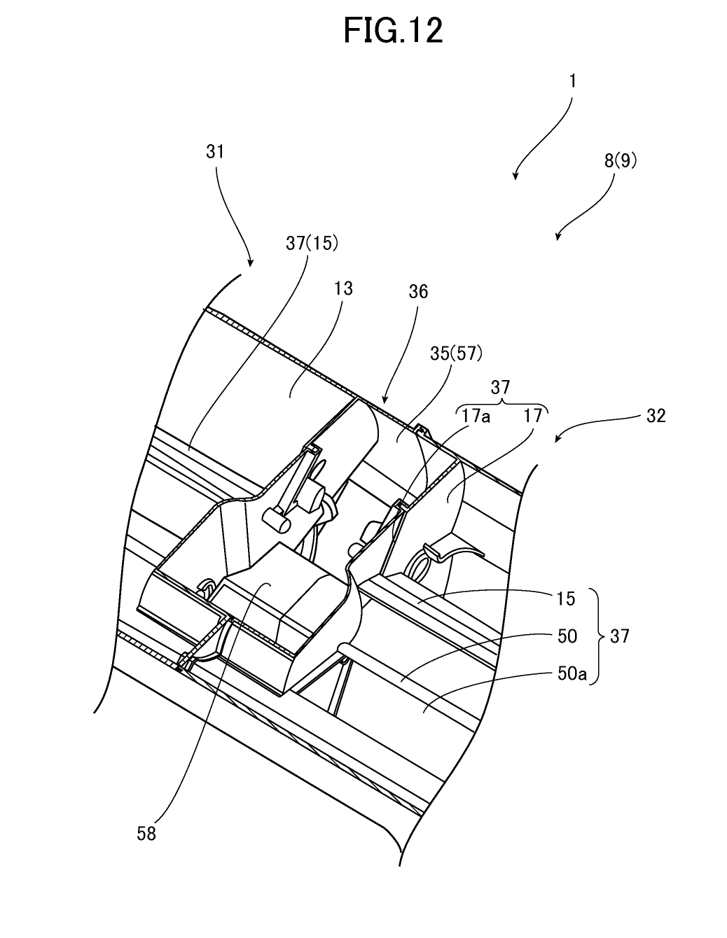

The air passage forming wall 37 functions to form the air passage inside the device body 8. Referring to FIGS. 7 and 11 (FIG. 12), the air passage forming wall 37 includes the above rear wall 15 of the air heating passage to separate between the air heating passage 5 and the foot passage 13, partitions 17 and top edges 17a to section between the rear passage 14 and the foot passage 13, and a top wall 50 of the air heating passage provided above the heating-purpose thermal exchanger 4 to form an outlet of the air heating passage 5 with the rear wall 15. The heating passage top wall 50 includes a later-described shaft support 50a. The width of the air passage forming wall 37 is set to be shorter or narrower by the width of the second spacing element 36 to support the second spacing element 36.

Specifically, the rear walls of the first outer case 31 and the second outer case 32 have a width corresponding to an approximately half of the width of the rear wall 16 of the device body 8. Meanwhile, the air passage forming walls 37 are shorter in width than the rear walls of the first outer case 31 and the second outer case 32 by the half width of the rear face of the second spacing element 36. The second spacing element 36 is held in a clamped state in a gap formed between the inner edges of the right and left shorter-width air passage forming walls 37. Although a joining portion of the air passage forming walls 37 and the second spacing element 36 is not explicitly shown in the drawings, a fitting member by a concavo-convex fitting or an inlay fitting can be provided, for example.

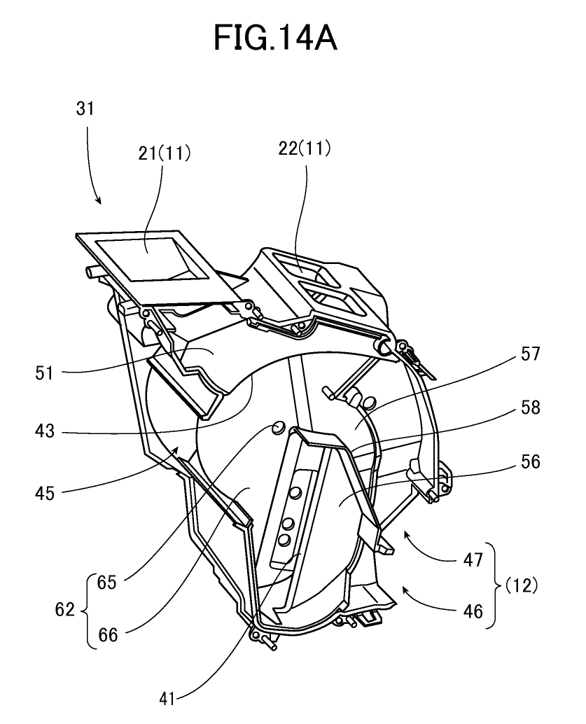

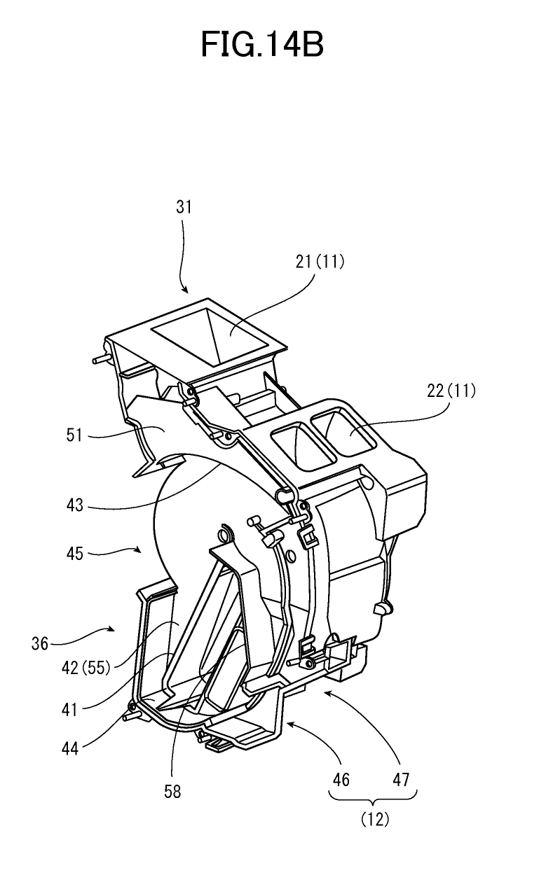

Referring to FIG. 8 and FIGS. 14A and 14B, the second spacing element 36 includes a support plate 51 above the top portion 43 to be able to support the inner surface of the top wall of the device body 8. The support plate 51 is provided at the center of the second spacing element 36 and propped up by the width center of the device body 8 from below. The top edge of the support plate 51 is shaped in line with the profile shapes of the defroster 21 and vent 22, that is, a bifurcated shape as seen laterally.

A bottom portion 44 and a front bottom of the second spacing element 36 are shaped to be placed in and fittable into the periphery of the bottom wall of the device body 8. The second spacing element 36 includes a fitting portion to the bottom wall, for example.

### (Structure 2)

As schematically shown in FIGS. 5, 13, the second spacing element 36 includes a first area dividing wall 55 which divides, into the first space 9 and the second space 35, an area more downstream than the heating-purpose thermal exchanger 4 in the flowing direction of the air-conditioning air 2.

### (Supplemental Explanation 2)

The first area dividing wall 55 is to divide the width of the heat exchanging surface of the heating-purpose thermal exchanger 4, for example, in the direction of the divided first and second outer cases 31, 32, into areas corresponding to the first space 9 and the second space 35. The right and left side surfaces 42 of the second spacing element 36 correspond to the first area dividing wall 55.

### (Structure 3)

As shown in FIGS. 8, 14A, and 14B, the second spacing element 36 includes a second area dividing wall 58 which divides the second space 35 into the second air heating passage 56 through the heating-purpose thermal exchanger 4 and the second cooled-air bypass 57 bypassing the heating-purpose thermal exchanger 4. The second area dividing wall 58 extends from the top of the heating-purpose thermal exchanger 4 to the second aperture 12 and forms a part of the second aperture 12.

### (Supplemental Explanation 3)

The second air heating passage 56 is intended for the rear seat, provided on the downstream side of the heating-purpose thermal exchanger 4, and connected to the aperture 46.

The second cooled-air bypass 27 is intended for the rear seat, provided to circumvent above the heating-purpose thermal exchanger 4, and connected to the aperture 47. The top portion 43 of the second spacing element 36 has a curved shape to largely go around above the top surface of the second air heating passage 56.

The second area dividing wall 58 functions to separate the second air heating passage 56 and the cooled-air bypass 57. The second area dividing wall 58 extends downward from the top of the heating-purpose thermal exchanger 4 to the middle of the height of the second aperture 12. The rear end of the second area dividing wall 58 is a partition to vertically divide the apertures 46 and 47 in the rear surface of the second spacing element 36.

### (Structure 4)

Referring to FIG. 7, an air-mix door 61 is provided in an upstream or inlet side of the mixing area 7 for the purpose of adjusting the mixing ratio of the air-conditioning air 2 heated by the heating-purpose thermal exchanger 4 and the air-conditioning air 2 cooled by the cooling-purpose thermal exchanger 3. Referring to FIG. 8 through FIGS. 10A to 10D, the second spacing element 36 includes an air-mix door mount 62 for placing an air-mix door 61 in an upstream portion of the heating-purpose thermal exchanger 4.

### (Supplemental Explanation 4)

The air-mix door 61 is a mechanism to adjust the temperature of the front seat provided between the inlet of the air heating passage 5 and the inlet of the cooled-air bypass 6. Various types of the air-mix door 61 are available. The air-mix door 61 according to the present embodiment is a single-sided structure in which the door is rotated around a rotational shaft.

The air-mix door mount 62 is for placing the air-mix door 61 inside the device body 8 and includes a shaft fitting 65 to support the rotational shaft and a side closure 66 of an approximate fan shape to cover the entire rotation area of the inner edge of the door. The shaft fitting is an opening connected to a shaft support 50a integrally formed with the front end of the top wall 50 of the air heating passage of the air passage forming wall 37. The side closure 66 is approximately flush with the right and left side surfaces 42, extending forward from the top of the front ends of the side surfaces 42 forming the upstream aperture 45 of the second spacing element 36.

Meanwhile, a second air-mix door 71 for adjusting the temperature of the rear seat is not placed inside the device body 8. A second air-mix door unit 72 including the second air-mix door 71 is separately provided and indirectly attached to the second aperture 12 of the device body 8, as shown in FIG. 8. The second aperture 12 of the device body 8 is a cut-off shape and located more inside than the rest of the rear wall 16 of the device body 8 as seen laterally, in order to mount the second air-mix door unit 72 in a space-efficient manner.

The second vent 24 and the second foot vent 25 are placed in the second aperture 12, referring to FIG. 5. With no use of the second foot vent 25, a closure plate 73 is integrally provided at a connecting portion of the second air-mix door unit 72 and the device body 8, to occlude the second foot vent 25, as shown in FIG. 1. The second foot vent 25 can be occluded in advance and opened by post processing only when used. This eliminates the necessity for providing the closure plate 73 for the second air-mix door unit 72.

The second air-mix door unit 72 is simply described. Referring to FIG. 8, the second air-mix door unit 72 includes a second air-mix door 71, a rear-seat vent passage 74, a rear-seat foot passage 75, and an air distributing valve 76 provided between the rear-seat vent passage 74 and the rear-seat foot passage 75 for distributing the flow amount of the air-conditioning air 2 to the passages 74 and 75. The rear-seat vent passage 74 is provided on the bottom while the rear-seat foot passage 75 is provided on the top.

A passage sectioning plate 77 (FIG. 1) can be used to section the inside of the second air-mix door unit 72 into areas horizontally or along the width and adjust the temperatures of the right and left sides of the rear seat. Thus, the air-conditioning device 1 can control the temperatures of the four seats independently.

### (Structure 5)

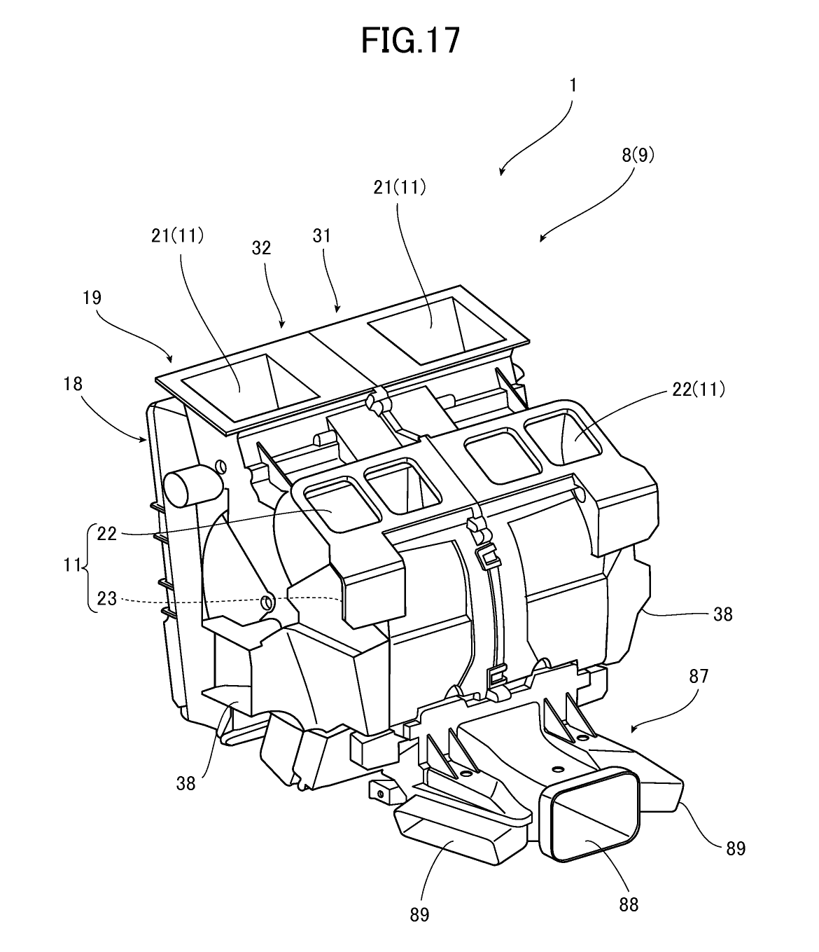

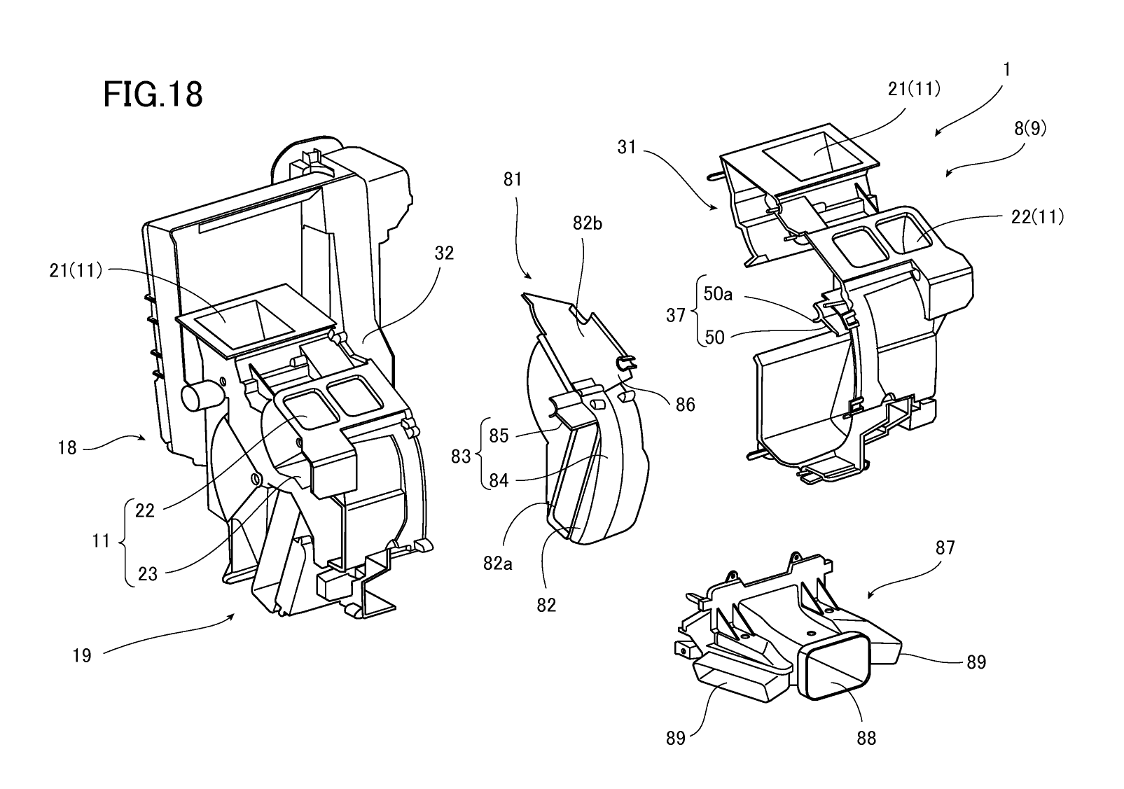

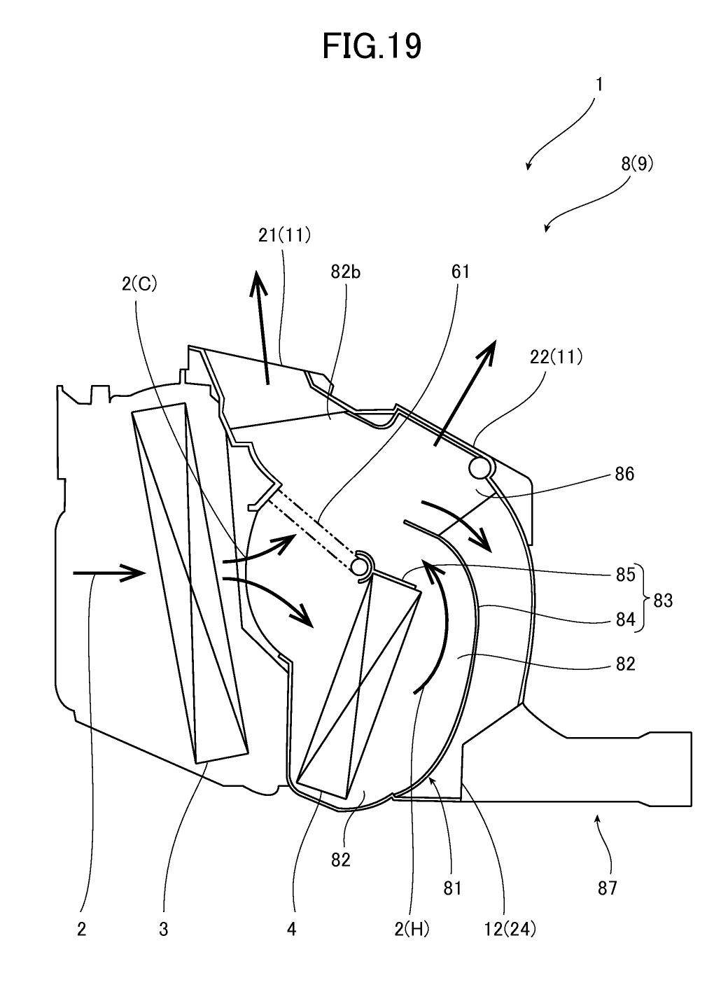

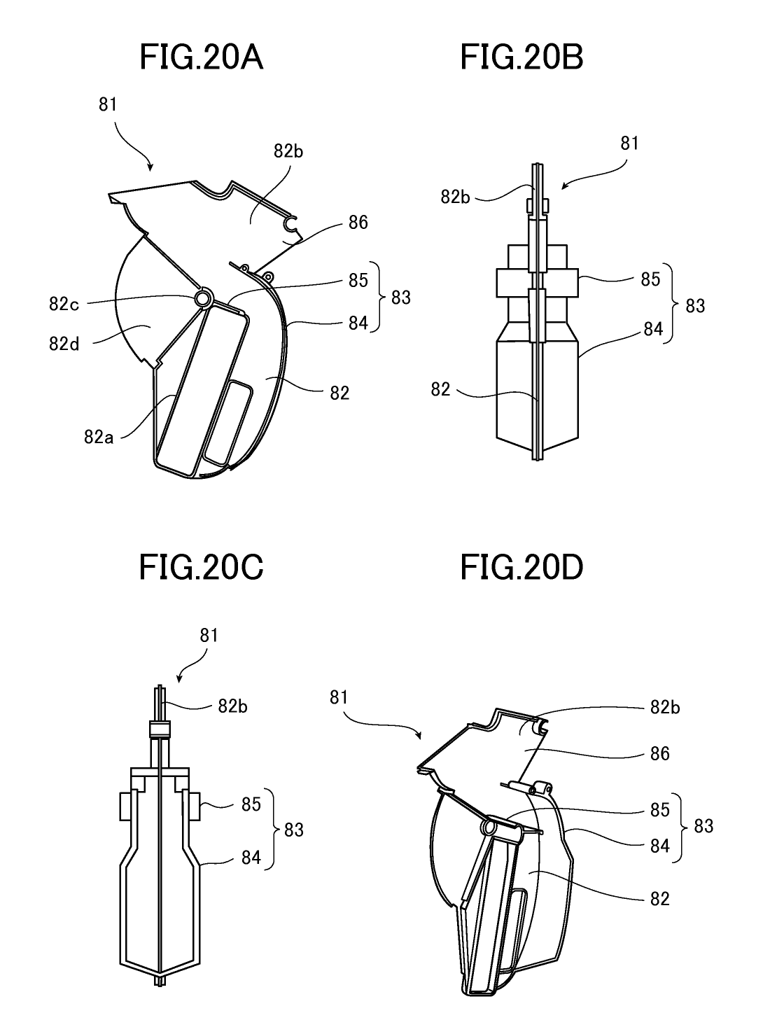

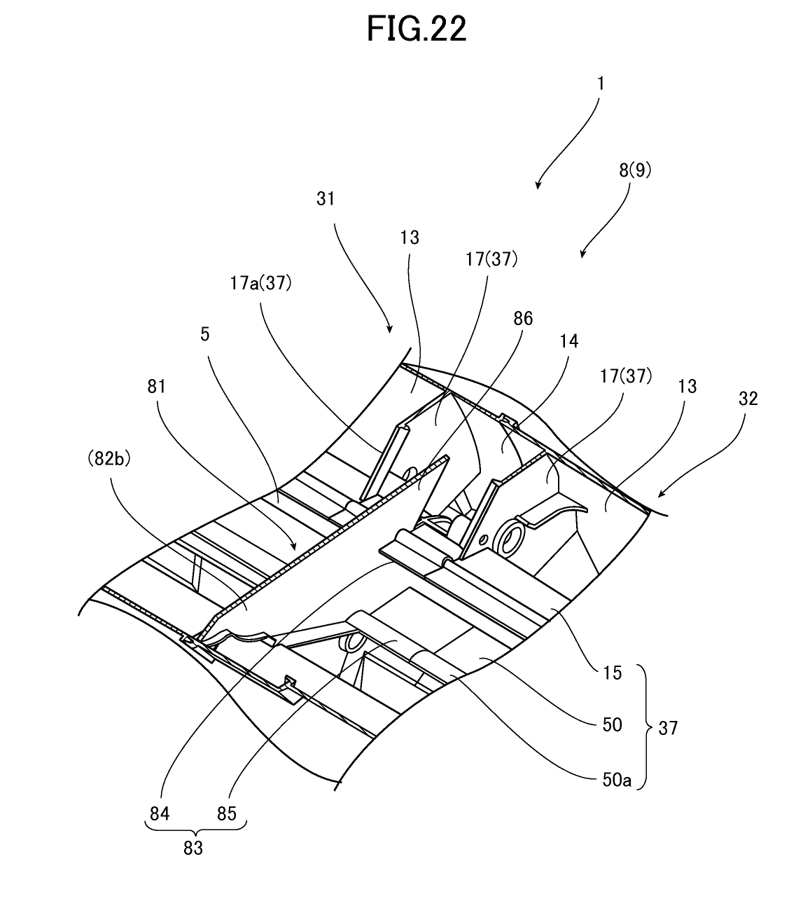

For another example, an inner partitioning element 81 (FIGS. 20A to 20D) can be provided in the first and second outer cases 31 and 32 of the device body 8 in place of the second spacing element 36 to divide the first space 9 into two, as shown in FIGS. 17 to 24, chiefly, the exploded perspective view and the vertical cross section in FIGS. 18 and 19. Similar to the second spacing element 36, the second spacing element 36 is supported by the air passage forming wall 37 forming the air passage inside the first outer case 31 and the second outer case 32, referring to FIGS. 21 and 22.

### (Supplemental Explanation 5)

The inner partitioning element 81 includes a partition plate 82 to horizontally section the inside of the device body 8 and a support 83 supported by the air passage forming wall 37. The inner partitioning element 81 is placed in the center of the width of the device body 8.

The partition plate 82 includes an opening into which the heating-purpose thermal exchanger 4 is inserted. The top end of the partition plate 82 is formed in a bifurcated shape (bifurcated portion 82b) as seen laterally, for example, in line with the profile shapes of the defroster 21 and vent 22, same as the support plate 51 of the second spacing element 36. The bottom edge of the partition plate 82 is shaped to be placed in and fittable into the periphery of the bottom wall of the device body 8, for example, same as the bottom portion 44 of the second spacing element 36.

Further, the inner partitioning element 81 includes, in the upstream portion of the heating-purpose thermal exchanger 4, an air-mix door mount for mounting the air-mix door 61. The air-mix door mount is equivalent to the air-mix door mount 62 of the second spacing element 36 and intended for placing the air-mix door 61 in the device body 8.

The air-mix door mount includes a shaft support 82c to support a rotational shaft and a side closure 82d of an approximate fan shape to cover the entire rotation range of the inner edge of the door, as shown in FIG. 20A. The shaft mount 82c is formed to protrude to both sides from the shaft hole and an edge of the shaft hole connected to the shaft support 50a integrally provided with the front end of the top wall 50 of the heating passage of the air passage forming wall 37. The side closure 82d extends forward from the top of the front edge to be approximately flush with the partition plate 82 of the inner partitioning element 81.

Further, the support 83 has the same width as that of the second spacing element 36 and extends from the partition plate 82 to both of the width ends. The support 83 includes a rear-wall support 84 and a front-wall support 85, for example. The rear-wall support 84 opposes the rear wall 15 while the front-wall support 85 opposes the top wall 50 (including the shaft support 50a) located at the top surface of the heating-purpose thermal exchanger 4. Note that no element is provided to oppose the top edges 17a of the partitions 17 to section between the rear passage 14 and the foot passage 13. Instead, a separation wall 86 is provided to be slightly inserted into the inlet of the rear passage 14 between the pair of partitions 17 (see FIGS. 21 and 22).

Further, with the inner partitioning element 81 placed inside the first and second outer cases 31 and 32, a rear-seat air passage element 87 is attached to the second aperture 12 in place of the second air-mix door unit 72. The rear-seat air passage element 87 is integrally provided with a rear-seat vent passage 88 connected to the second vent 24 and rear-seat foot passages 89 connected to the second foot vent 25. The rear-seat vent passage 88 is placed at the center and the rear-seat foot passages 89 are placed at both ends of the passage 88.

### <Operation>

In the following the operation of the present embodiment will be described.

(Operation with Use of Second Spacing Element 36)

First, the second spacing element 36 is placed inside the first and second outer cases 31 and 32 to form the first space 9 and the second space 35 in the device body 8. The following operation is performed in the first space 9.

Referring to FIG. 7, the air-conditioning air 2 is defumified and cooled by the cooling-purpose thermal exchanger 3, heated through the air heating passage 5 by the heating-purpose thermal exchanger 4, and transmitted to the mixing area 7 or passes through the cooled-air bypass 6 to the mixing area 7. The flow amount of the air-conditioning air 2 to the air heating passage 5 and the cooled-air bypass 6 is adjusted with the air-mix door 61. The heated air-conditioning air 2 by the heating-purpose thermal exchanger 4 and the cooled air-conditioning air 2 through the cooled-air bypass 6 are mixed in the mixing area 7 to be adjusted in temperature and blow from the first aperture 11 to the front seat.

A blow mode can be set with a not-shown controller to blow the air temperature-controlled in the mixing area 7 from the defroster 21, vent 22, or foot vent 23 when appropriate.

The air-conditioning air 2 is blown from the defroster 21 to a not-shown windshield for anti-fog purpose. The air-conditioning air 2 is blown from the vent 22 to the upper body or chest of a front-seat occupant. The air-conditioning air 2 is blown from the foot vent 23 provided at the inlet of the foot passage 13 to the lower body or feet of the front-seat occupant.

The rear passage 14 and the second vent 24 are used for the second spacing element 36, as described later. The second foot vent 25 is occluded with the closure plate 73 of the second air-mix door unit 72 and therefore unusable.

The operation in the second space is as follows.

Referring to FIG. 8, the air-conditioning air 2 is defumified and cooled by the cooling-purpose thermal exchanger 3 and distributed into the second air heating passage 56 and the second cooled-air bypass 57 of the second spacing element 36 divided by the second area dividing wall 58. The air-conditioning air 2 is heated by the heating-purpose thermal exchanger 4 through the second air heating passage 56 and sent to the bottom side of the second vent 24 of the second aperture 12. Passing through not the air heating passage 5 but the second cooled-air bypass 57, the air-conditioning air 2 is sent to the top side of the second vent 24 of the second aperture 12. Then, the heated air-conditioning air 2(H) from the second air heating passage 56 and the cooled air-conditioning air 2(C) from the second cooled-air bypass 57 are controlled in temperature by the second air-mix door 71 of the second air-mix door unit 72 connected to the second vent 24, distributed via the air distributing valve 76 into the rear-seat vent passage 74 and the rear-seat foot passage 75, and adjusted in amount to blow the rear seat.

(Operation with Use of the Inner Partitioning Element 81)

Meanwhile, with the inner partitioning element 81 placed inside the first and second outer cases 31 and 32 to section the first space of the device body 8 into two, for example, horizontally, the temperature of the air-conditioning air 2 is controlled in the right and left first spaces 9 in the same manner as in the first space 9 formed by the second spacing element 36.

A blow mode can be set with a not-shown controller to blow the air temperature-controlled in the mixing area 7 from the defroster 21, vent 22, foot vent 23, second vent 24, or second foot vent 25 when appropriate.

As described above, the air-conditioning air 2 is blown from the defroster 21 to the not-shown windshield for anti-fog purpose. The air-conditioning air 2 is blown from the vent 22 to the upper body or chest of a front-seat occupant. The air-conditioning air 2 is blown from the foot vent 23 provided at the inlet of the foot passage 13 to the lower body or feet of the front-seat occupant.

The air-conditioning air 2 is also blown from the second vent 24 provided at the outlet of the rear passage 14 to the upper body or chest of a rear-seat occupant. The air-conditioning air 2 is blown from the second foot vent 25 provided at the outlet of the foot passage 13 to the lower body or feet of the rear-seat occupant.

The temperature and amount of the air are not adjusted for the rear seat. The remaining of the air-conditioning air 2 blown from the first aperture 11 is blown from the second vent 24 through the rear passage 14. Further, the remaining of the air-conditioning air 2 blown from the foot vent 23 is blown from the second foot vent 25 through the foot passage 13.

### (Other Operation)

Although not described in detail, the first space 9 is usable without the second spacing element 36 and the inner partitioning element 81 placed inside the first and second outer cases 31 and 32. In this case an element equivalent to the support 83 of the inner partitioning element 81 is provided in the air passage forming wall 37 to support the first space 9.

### <Effects>

The present embodiment can achieve the following effects.

### (Effect 1)

The second spacing element 36 is placed inside the first and second outer cases 31 and 32 to form multiple independent air-conditioning spaces, that is, the first and second spaces 9 and 35.

The second spacing element 36 is supported by the air passage forming wall 37 provided inside the first and second outer cases 31 and 32. Thereby, the first and second outer cases 31 and 32 can include multiple independent air-conditioning spaces without a change in the joining portion of the outer cases 31 and 32.

Meanwhile, if the second spacing element 36 is supported by the joining portion of the first and second outer cases 31 and 32, an additional support structure for the second spacing element 36 is needed on the joining portion. Accordingly, it is necessary to change the shape of the joining portion depending on presence or absence of the second spacing element 36.

Thus, with no need to change the joining portion of the first and second outer cases 31 and 32, two independent air-conditioning spaces such as the first spaces 9 can be simply formed in the device body 8 by interposing the inner partitioning element 81 or partition plate between the first and outer cases 31 and 32.

The device body 8 includes the second spacing element 36 and independent air-conditioning spaces as the first and second spaces 9 and 35 to independently control the temperatures of the air-conditioning spaces with independent temperature controllers such as the air-mix door 61 and the second air-mix door unit 72.

In addition, a dedicated structure for independently controlling the temperatures of two or many seats can be provided simply without changing the shapes of the outer cases 31 and 32, by selectively attaching either the second spacing element 36 or the inner partitioning element 81 to the device body 8. This can achieve cost reduction.

### (Effect 2)

The second spacing element 36 is configured to include the first area dividing wall 55 which divides, into the first and second spaces 9 and 35, the area more downstream than the heating-purpose thermal exchanger 4 in the direction of the flow of the air-conditioning air 2. Thereby, the heating-purpose thermal exchanger 4 can be used for the two divided areas, the first space 9 and the second space 35.

This makes it possible to improve the temperature controllability to the independent first and second spaces 9 and 35.

Moreover, owing to the first area dividing wall 55 of the second spacing element 36, it is made unnecessary to additionally provide a partition or partitioning structure which divides the area for the heating-purpose thermal exchanger 4. The inner structure of the device body 8 can be thus simplified.

### (Effect 3)

The second spacing element 36 is configured to include the second area dividing wall 58 which divides the second space 35 into the second air heating passage 56 passing through the heating-purpose thermal exchanger 4 and the second cooled-air bypass 57 bypassing the heating-purpose thermal exchanger 4. The second area dividing wall 58 is able to securely divide the second space 35. Further, the second area dividing wall 58 extends from the top position of the heating-purpose thermal exchanger 4 to the second aperture 12 to form a part of the second aperture 12 and guide the second air heating passage 56 and the second cooled-air bypass 57 to the second aperture 12.

Thereby, it is made possible to independently control the temperature of the air-conditioning air 2 from the second aperture 12 in the second air-mix door 71 by attaching the second air-mix door unit 72 having the second air-mix door 71 to the second aperture 12. In addition, by dividing the inside of the second air-mix door unit 72 into two, the temperatures of the air-conditioning air 2 from the two portions of the second aperture 12 can be independently controlled.

Accordingly, without a change in the structure of the device body 8 and only by attaching the second air-mix door unit 72, the air-conditioning device can be adapted to the independent temperature control for multiple seats. The device body 8 can thus have high extendibility.

### (Effect 4)

The air-mix door 61 is provided to adjust the mixing ratio of the air-conditioning air 2 heated by the heating-purpose thermal exchanger 4 and the air-conditioning air 2 cooled by the cooling-purpose thermal exchanger 3. The second spacing element 36 includes the air-mix door mount 62 for the air-mix door 61 more upstream than the heating-purpose thermal exchanger 4 in the direction of the air-conditioning air flow. This eliminates the necessity for providing an additional structure for mounting the air-mix door 61 inside the device body 8. The structure and function of the device body 8 can be integrated and the device body 8 can be compact in size.

### (Effect 5)

As described above, the inner partitioning element 81 is placed in the device body 8 to divide the inside of the device body 8 into the two first spaces 9 and attach the air-mix door 61 to each of the air-conditioning spaces. Thereby, the temperatures of multiple seats can be independently controlled.

Although the present invention has been described in terms of exemplary embodiments referring to the accompanying drawings, it is not limited thereto. It should be appreciated that variations or modifications may be made in the embodiments described by persons skilled in the art without departing from the scope of the present invention as defined by the following claims. For instance, if each embodiment includes a number of configurations, a combination of the configurations is construed to be embodied in the present invention without an explicit description. Further, if a number of embodiments and modified examples of the present invention are disclosed, possible combinations thereof are construed to be embodied in the present invention without an explicit description. The structures shown in the drawings are also construed to be embodied in the present invention without an explicit description. Moreover, the term, “or the like” refers to the inclusion of an equivalent. The terms, “approximately”, “about”, and “degree” refer to the inclusion of a range or an accuracy which is commonly admitted.

1. A vehicle air-conditioning device, comprising
a device body including
a cooling-purpose thermal exchanger which cools air-conditioning air,
a heating-purpose thermal exchanger which heats the air-conditioning air,
an air passage including an air heating passage in which the heating-purpose thermal exchanger is provided and a cooled-air bypass to bypass the heating-purpose thermal exchanger,
a mixing area in which heated air-conditioning air from the air heating passage and cooled air-conditioning air from the cooled-air bypass are mixed,
a first space, and
a first aperture and a second aperture on an outer surface to face the first space, wherein:
the device body includes two-divided, first outer case and second outer case, a second spacing element which forms a second space and is placed such that the second space is placed in the first space to face the second aperture, and an air passage forming wall which forms the air passage inside the first outer case and the second outer case and supports the second spacing element.

2. The vehicle air-conditioning device according to claim 1, wherein
the second spacing element includes a first area dividing wall which divides, into the first space and the second space, an area more downstream than the heating-purpose thermal exchanger in a direction of a flow of the air-conditioning air.

3. The vehicle air-conditioning device according to claim 1, wherein:
the second spacing element includes a second area dividing wall which divides the second space into a second air heating passage passing through the heating-purpose thermal exchanger and a second cooled-air bypass bypassing the heating-purpose thermal exchanger; and
the second area dividing wall is configured to extend from an upper position of the heating-purpose thermal exchanger to the second aperture and form a part of the second aperture.

4. The vehicle air-conditioning device according to claim 1, further comprising
an air-mix door provided in an upstream of the mixing area to adjust a mixing ratio of the air-conditioning air heated by the heating-purpose thermal exchanger and the air-conditioning air cooled by the cooling-purpose thermal exchanger, wherein
the second spacing element includes an air-mix door mount more upstream than the heating-purpose thermal exchanger in the direction of the air-conditioning air flow, the air-mix door mount to which the air-mix door is attached.
